(19) United States
(12) Patent Application Publication
(10) Pub. No.: US 2014/0245138 A1
(43) Pub. Date: Aug. 28, 2014

(54) DOCUMENT CONVERSION AND PRINTING

(71) Applicant: HEWLETT-PACKARD DEVELOPMENT COMPANY, L.P., Fort Collins, CO (US)

(72) Inventors: Shinoj PRABHAKARAN, Bangalore (IN); Rinu Rajan, Bangalore (IN)

(73) Assignee: Hewlett-Packard Development Company, L.P., Fort Collins, CO (US)

(21) Appl. No.: 13/777,061

(22) Filed: Feb. 26, 2013

(51) Int. Cl. G06F 17/21

(52) U.S. Cl. CPC G06F 17/212
USPC 715/274

(57) ABSTRACT

A system for converting and printing documents is disclosed herein. An example includes a repository having a plurality of documents and a user-interface to select at least one of the documents from the repository. The system also includes a non-volatile storage medium having instructions that, when executed by a processor, cause the processor to provide a prompt via the user interface for each selected document permitting choice between printing the document to a local area network printer, printing the document to a cloud-based printer, or converting the document to a predetermined format The non-volatile storage medium includes additional instructions that, when executed by the processor, cause the processor to render the document based on the choice made in response to the prompt. Examples of a method for use in a document management system and a non-volatile storage medium are also disclosed herein.

### BACKGROUND

Repositories can be hosted sites where access is granted to end-users to search and review stored documents. End-users of such sites appreciate ease of use of and enhanced features to such repositories. Designers and service providers may, therefore, endeavor to create and host such repositories directed to one or more of these objectives.

### BRIEF DESCRIPTION OF THE DRAWINGS

The following detailed description references the drawings, wherein:

FIG. 1 is an example of a block diagram of a system for converting and printing documents.

FIG. 2 is an example of a non-volatile storage medium.

FIG. 3 is an example of additional instructions that may be included on the non-volatile storage medium of FIG. 2.

FIG. 4 is an example of a method for use in a document management system.

FIG. 5 is an example of additional possible elements of the method of FIG. 4.

### DETAILED DESCRIPTION

A repository can be a hosted site that allows end-users to search for and retrieve documents stored in the repository. The documents may then be reviewed by such end-users.

At some point in time, an end-user of the repository may want to print one or more of the documents that he or she has retrieved. The ability to automatically accomplish this printing on the hosted site or server-side, rather than the end-user or client-side, is a beneficial feature that would make such a repository easier to use. Otherwise, an end-user must download each document to his or her client-side, convert each document to an appropriate print format, locate an available printer, install any necessary printer drivers or updates not already present, and then send each converted document to the printer for processing.

Additionally or alternatively, at some point in time, an end-user of the repository may want to convert one or more of the documents that he or she has retrieved. The ability to automatically accomplish this conversion on the hosted site or server-side, rather than the end-user or client-side, is a beneficial feature that would make such a repository easier to use. Otherwise, an end-user must download each document to his or her client-side and then convert each document to a desired format.

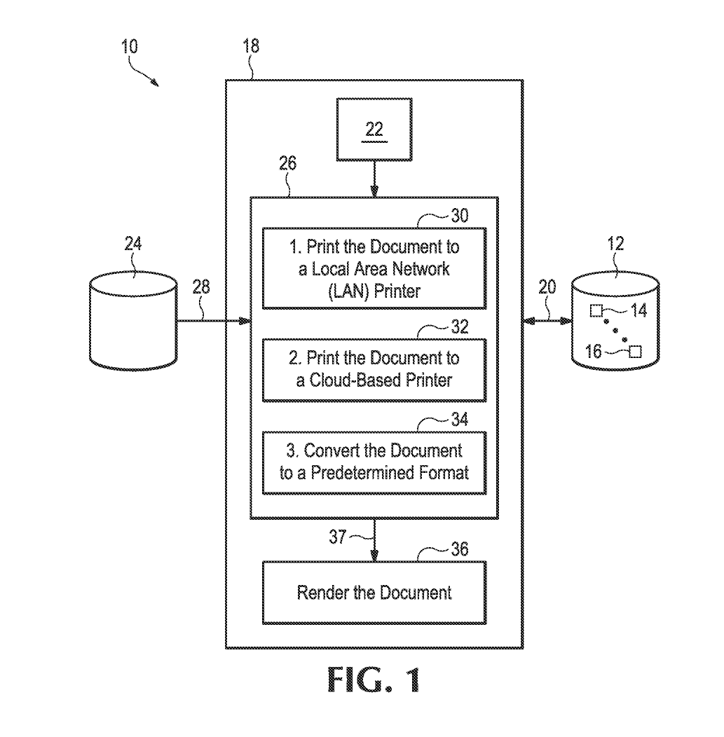

An example of a block diagram of a system 10 for converting and printing documents directed to these objectives is illustrated in FIG. 1. As used herein, the term “non-volatile storage medium” is defined as including, but not necessarily limited to, any media that can contain, store, retain, or maintain programs, code, scripts, information, and/or data. A non-volatile storage medium may include any one of many physical media such as, for example, electronic, magnetic, optical, electromagnetic, or semiconductor media. More specific examples of suitable non-volatile storage media include, but are not limited to, a magnetic computer diskette such as floppy diskettes or hard drives, magnetic tape, a read-only memory (ROM), an erasable programmable read-only memory (EPROM), a flash drive, a compact disc (CD), a digital video disk (DVD), or a memristor.

As used herein, the term “processor” is defined as including, but not necessarily limited to, an instruction execution system such as a computer/processor based system, an Application Specific Integrated Circuit (ASIC), a computing device, or a hardware and/or software system that can fetch or obtain the logic from a non-volatile storage medium and execute the instructions contained therein. “Processor” can also include any controller, state-machine, microprocessor, cloud-based utility, service or feature, or any other analogue, digital and/or mechanical implementation thereof.

As used herein, the terms “cloud” and “cloud-based” are defined as including, but not necessarily limited to, the use of resources that are delivered as a service over a network, such as the internet. The resources can be hardware and/or software based. Examples include cloud-based printing, storage, security, word processing applications, financial applications, etc. As used herein, the term “document management system” is defined as including, but not necessarily limited to, a computer system (or set of computer programs) used to track, store, view and/or organize electronic documents.

As used herein, the term “repository” is defined as including, but not necessarily limited to, a non-volatile storage medium on which documents are stored as part of a document management system. As used herein, “user interface” is defined as including, but not necessarily limited to, any graphical, textual and/or auditory medium that permits documents in a repository to be viewed, sorted, searched and/or selected via use of one or more input devices such as a keyboard, mouse, touch screen, or microphone.

As used herein, the term “prompt” is defined as including, but not necessarily limited to, a way of indicating to an end-user a need for or a requirement to provide a response or command. The prompt may be provided in any of a variety of ways, such as via a graphical user interface or a command-line user interface. Examples of prompts include, but are not limited to, a choice to be made from a list of options, one or more graphical user interface “buttons” to be selected or pressed, a dialog box, a drop-down menu, etc.

As used herein, the term “printer” is defined as including, but not necessarily limited to, a peripheral that produces a representation of a document on one or both sides of media such as paper, transparency, fabric, etc. A printer can be single function or multi-function (i.e., including scanning, faxing, or other functionality). A printer can use any of a variety of different types of marking technologies such as laser, inkjet, dye-sublimation, off-set printing, thermal printing, impact, etc.

Referring again to FIG. 1, system 10 includes a repository 12 having a plurality of documents 14 through 16 and a user interface 18 to select at least one of documents 14 through 16 from repository 12, as generally indicated by double-headed arrow 20. In this example, one document 22 has been selected. Documents 14 through 16 may be in the same format or any of a variety of different formats such as: portable document format, hyper text markup language, open extensible markup language paper specification, text, joint photographic experts group, tagged image file format, graphics interchange format, etc.

As can be seen in FIG. 1, system 10 additionally includes a non-volatile storage medium 24 having instructions that, when executed by a processor (not shown), cause the processor to provide a prompt 26, as generally indicated by arrow 28, via user interface 18 for each selected document 22 permitting a choice between printing the document to a local area network (LAN) printer 30, printing the document to a cloud-based printer 32, or converting the document to a predetermined format 34.

As can additionally be seen in FIG. 1, non-volatile storage medium 24 also includes instructions that, when executed by the processor, cause the processor to render document 22 based on the choice made in response to prompt 26, as indicated by both block 36 and arrow 37.

This rendering automatically occurs on the hosted or server-side, rather than the end-user or client-side which, as noted above, is a beneficial feature that saves time and effort on the part of end-users of system 10. An additional benefit is that the administrator of a document management system and associated repository can control or limit which documents may be printed and/or converted, versus only viewed.

The local area network (LAN) printer and/or the cloud-based printer can be on the hosted or server side, the end-user or client side, or a different location. Additionally or alternatively, the predetermined format to which a document is converted during rendering may be any of a variety of different formats, including, without limitation, portable document format, an open extensible markup language paper specification, a printer command language, post script, hyper text markup language, text, joint photographic experts group, tagged image file format, graphics interchange format, etc.

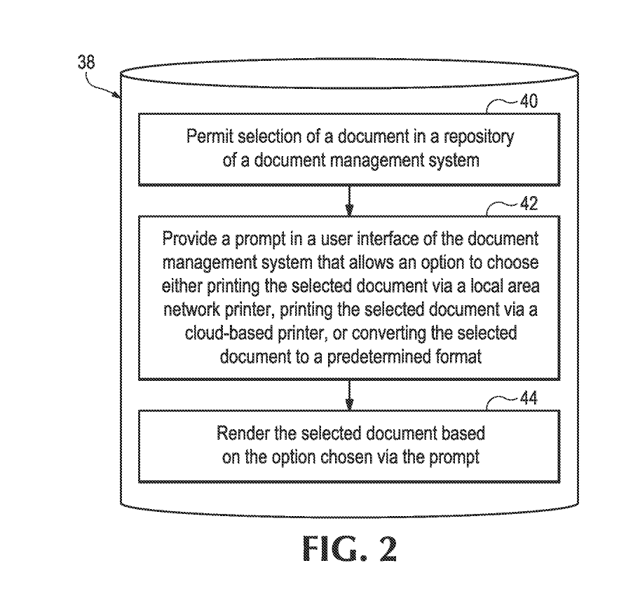

An example of a non-volatile storage medium 38 is shown in FIG. 2. As can be seen in FIG. 2, non-volatile storage medium 38 includes instructions that, when executed by a processor (not shown), cause the processor to permit selection of one or more documents in a repository of a document management system, as indicated by block 40 in FIG. 2. As can also be seen in FIG. 2, non-volatile storage medium 38 additionally includes instructions that, when executed by the processor, cause the processor to provide a prompt in a user interface of the document management system that allows an option to choose either printing the selected document via a local area network printer, printing the selected document via a cloud-based printer, or converting the selected document to a predetermined format, as indicated by block 42. As can further be seen in FIG. 2, non-volatile storage medium 38 also includes instructions that, when executed by the processor, cause the processor to render the selected document based on the option chosen via the prompt, as indicated by block 44.

As noted above, the local area network (LAN) printer and/or the cloud-based printer can be on the hosted or server side, the end-user or client side, or a different location. Additionally or alternatively, as also noted above, the predetermined format to which a document is converted during rendering may be any of a variety of different formats, including, without limitation, portable document format, an open extensible markup language paper specification, a printer command language, post script, hyper text markup language, text, joint photographic experts group, tagged image file format, graphics interchange format, etc.

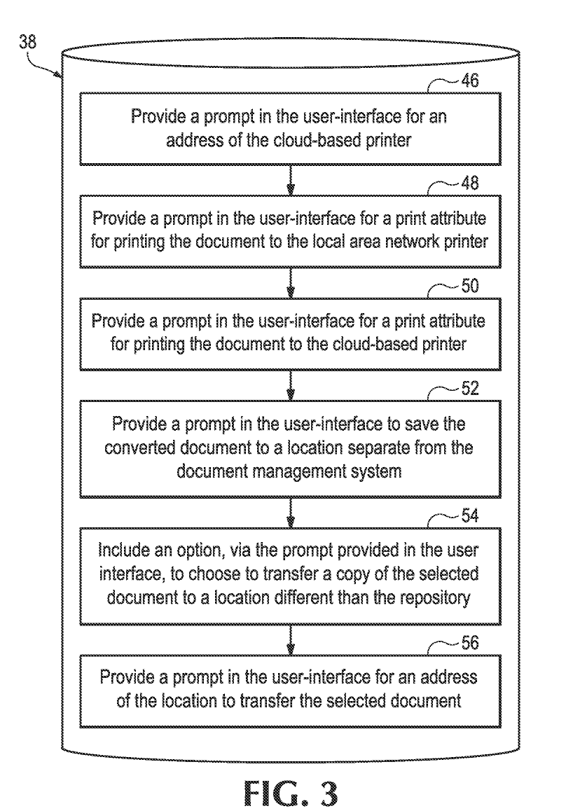

An example of additional instructions that may be included on non-volatile storage medium 38 is shown in FIG. 3. One or more of these additional instructions may also be included on non-volatile storage medium 24 of system 10 of FIG. 1. Therefore, the following discussion of non-volatile storage medium 38 is also applicable to non-volatile storage medium 24.

As can be seen in FIG. 3, non-volatile storage medium 38 may include additional instructions that, when executed by the processor, cause the processor to provide a prompt in the user-interface for an address of the cloud-based printer, as indicated by block 46. Upon entry or selection of this address by an end-user, the selected document or documents may be printed by the cloud-based printer without any further action required on the part of the end-user.

As can also be seen in FIG. 3, non-volatile storage medium 38 may include additional instructions that, when executed by the processor, cause the processor to provide a prompt in the user-interface for a print attribute (e.g., page size, orientation, duplex printing, watermarking, etc.) for printing the document to the local area network printer, as indicated by block 48, and/or the cloud-based printer, as indicated by block 50.

As can additionally be seen in FIG. 3, non-volatile storage medium 38 may include additional instructions that, when executed by the processor, cause the processor to provide a prompt in the user-interface to save the converted document to a location separate from the document management system, as indicated by block 52. This location may be any of a variety of different places such as, for example, a client-side non-volatile storage medium of a computing device of an end user or another document management system. The various possible locations may be displayed in the user-interface for selection by an end-user or, alternatively, the end-user may manually enter an address of the location.

Additionally or alternatively, the end-user may be presented with the option to select a predetermined format to which a document is saved. This predetermined format may be any of a variety of different formats, including, without limitation, portable document format, an open extensible markup language paper specification, hyper text markup language, text, joint photographic experts group, tagged image file format, graphics interchange format, etc.

As can further be seen in FIG. 3, non-volatile storage medium 38 may include additional instructions that, when executed by the processor, cause the processor to include an option, via the prompt provided in the user interface, to choose to transfer a copy of the selected document to a location different than the repository, as indicated by block 54. This location may be any of a variety of different places such as, for example, a client-side non-volatile storage medium of a computing device of an end user or another document management system.

As can still further be seen in FIG. 3, non-volatile storage medium 38 may include additional instructions that, when executed by the processor, cause the processor to provide a prompt in the user-interface for an address of the location to transfer the selected document, as indicated by block 56. The various possible locations may be displayed in the user-interface for selection by an end-user or, alternatively, the end-user may manually enter an address of the location.

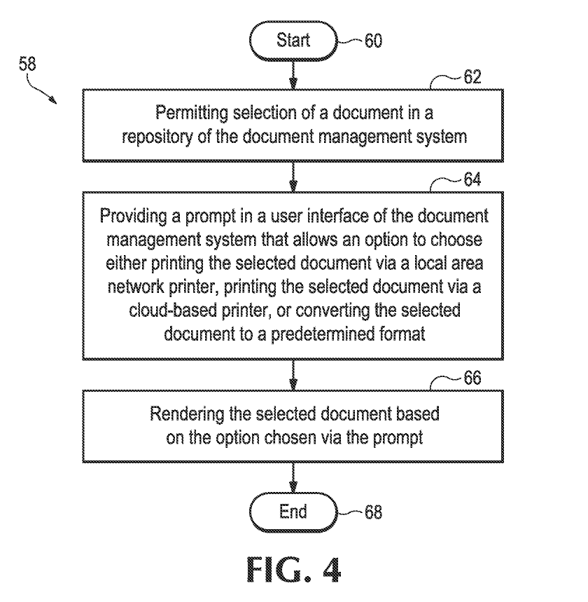

An example of a method 58 for use in a document management system is illustrated in FIG. 4. As can be seen in FIG. 4, method 58 starts or begins 60 by permitting selection of a document in a repository of the document management system, as indicated by block 62. Method 58 continues by providing a prompt in a user interface of the document management system that allows an option to choose either printing the selected document via a local area network printer, printing the selected document via a cloud-based printer, or converting the selected document to a predetermined format, as indicated by block 64. Method 58 additionally continues by rendering the selected document based on the option chosen via the prompt, as indicated by block 66. Method 58 may then end 68.

The local area network (LAN) printer and/or the cloud-based printer can be on the hosted or server side, the end-user or client side, or a different location. Additionally or alternatively, the predetermined format to which a document is converted during rendering may be any of a variety of different formats, including, without limitation, portable document format, an open extensible markup language paper specification, a printer command language, post script, hyper text markup language, text, joint photographic experts group, tagged image file format, graphics interchange format, etc.

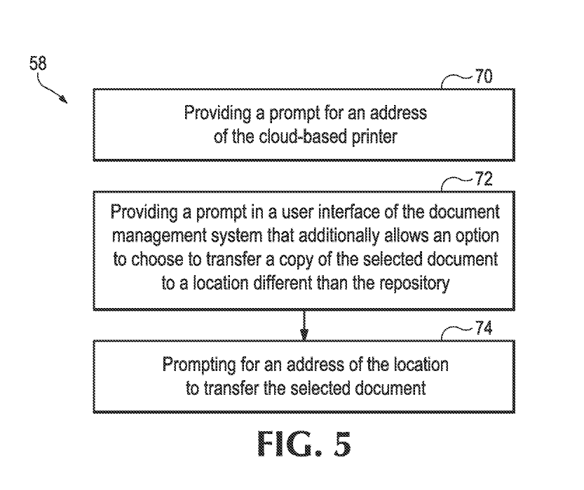

An example of additional possible elements of method 58 is illustrated in FIG. 5. As can be seen in FIG. 5, method 58 may also include providing a prompt for an address of the cloud-based printer, as indicated by block 70. Upon entry or selection of this address by an end-user, the selected document or documents may be printed by the cloud-based printer without any further action required on the part of the end-user.

Alternatively or additionally, method 58 may include providing a prompt in the user interface of the document management system that allows an option to choose to transfer a copy of the selected document to a location different than the repository, as indicated by block 72. In such cases, method 58 may include prompting for an address of the location to transfer the selected document, as indicated by block 74. The various possible locations may be displayed in the user-interface for selection by an end-user or, alternatively, the end-user may manually enter an address of the location.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A system for converting and printing documents, comprising:
a repository including a plurality of documents;
a user-interface to select at least one of the documents from the repository; and
a non-volatile storage medium including instructions that, when executed by a processor, cause the processor to:
provide a prompt via the user interface for each selected document permitting choice between printing the document to a local area network printer, printing the document to a cloud-based printer, and converting the document to a predetermined format, and
render the document based on the choice made in response to the prompt.

2. The system of claim 1, wherein the non-volatile storage medium includes additional instructions that, when executed by the processor, cause the processor to provide a prompt in the user-interface for an address of the cloud-based printer.

3. The system of claim 1, wherein the non-volatile storage medium includes additional instructions that, when executed by the processor, cause the processor to provide a prompt in the user-interface for a print attribute for printing the document to the local area network printer.

4. The system of claim 1, wherein the non-volatile storage medium includes additional instructions that, when executed by the processor, cause the processor to provide a prompt in the user-interface for a print attribute for printing the document to the cloud-based printer.

5. The system of claim 1, wherein the non-volatile storage medium includes additional instructions that, when executed by the processor, cause the processor to provide a prompt in the user-interface to save the converted document to a location separate from the system.

6. The system of claim 1, wherein the predetermined format includes one of a portable document format, an open extensible markup language paper specification, a printer command language, post script, hyper text markup language, text, joint photographic experts group, tagged image file format, and graphics interchange format.

7. The system of claim 1, wherein the prompt provided in the user interface for each selected document additionally includes an option to choose to transfer a copy of the selected document to a location different than the repository.

8. The system of claim 7, wherein the non-volatile storage medium includes additional instructions that, when executed by the processor, cause the processor to provide a prompt in the user-interface for an address of the location to transfer the selected document.

9. A non-volatile storage medium including instructions that, when executed by a processor, cause the processor to:
permit selection of a document in a repository of a document management system;
provide a prompt in a user interface of the document management system that allows an option to choose one of printing the selected document via a local area network printer, printing the selected document via a cloud-based printer, and converting the selected document to a predetermined format; and
render the selected document based on the option chosen via the prompt.

10. The non-volatile storage medium of claim 9, further comprising additional instructions that, when executed by the processor, cause the processor to provide a prompt in the user-interface for an address of the cloud-based printer.

11. The non-volatile storage medium of claim 9, further comprising additional instructions that, when executed by the processor, cause the processor to provide a prompt in the user-interface for a print attribute for printing the document to the local area network printer.

12. The non-volatile storage medium of claim 9, further comprising additional instructions that, when executed by the processor, cause the processor to provide a prompt in the user-interface for a print attribute for printing the document to the cloud-based printer.

13. The non-volatile storage medium of claim 9, further comprising additional instructions that, when executed by the processor, cause the processor to provide a prompt in the user-interface to save the converted document to a location separate from the document management system.

14. The non-volatile storage medium of claim 9, wherein the predetermined format includes one of a portable document format, an open extensible markup language paper specification, and a printer command language.

15. The non-volatile storage medium of claim 9, further comprising additional instructions that, when executed by the processor, cause the processor to include an option, via the prompt provided in the user interface, to choose to transfer a copy of the selected document to a location different than the repository.

16. The non-volatile storage medium of claim 15, further comprising additional instructions that, when executed by the processor, cause the processor to provide a prompt in the user-interface for an address of the location to transfer the selected document.

17. A method for use in a document management system, the method comprising:
permitting selection of a document in a repository of the document management system;
providing a prompt in a user interface of the document management system that allows an option to choose one of printing the selected document via a local area network printer, printing the selected document via a cloud-based printer, and converting the selected document to a predetermined format; and
rendering the selected document based on the option chosen via the prompt.

18. The method of claim 17, further comprising providing a prompt for an address of the cloud-based printer.

19. The method 17, wherein providing a prompt in the user interface of the document management system for each selected document additionally includes an option to choose to transfer a copy of the selected document to a location different than the repository.

20. The method of claim 19, further comprising prompting for an address of the location to transfer the selected document.
